(19) United States
(12) Patent Application Publication
(10) Pub. No.: US 2022/0004870 A1
(43) Pub. Date: Jan. 6, 2022

(54) SPEECH RECOGNITION METHOD AND APPARATUS, AND NEURAL NETWORK TRAINING METHOD AND APPARATUS

(71) Applicant: Tencent Technology (Shenzhen) Company Limited, Shenzhen (CN)

(72) Inventors: Jun WANG, Shenzhen (CN); Wing Yip LAM, Shenzhen (CN); Dan SU, Shenzhen (CN); Dong YU, Shenzhen (CN)

(21) Appl. No.: 17/476,345

(22) Filed: Sep. 15, 2021

Related U.S. Application Data
(63) Continuation of application No. PCT/CN2020/110742, filed on Aug. 24, 2020.

(51) Int. Cl. G06N 3/08; G06N 3/04; G10L 15/06; G10L 15/02; G10L 25/51

(52) U.S. Cl. CPC G06N 3/08; G06N 3/0454; G10L 25/51; G10L 15/063; G10L 15/02; G06N 3/0481

(57) ABSTRACT

This application provides a speech recognition and apparatus and a neural network training method and apparatus, and relates to the field of Artificial Intelligence (AI) technologies. The neural network training method is performed by an electronic device and includes: obtaining sample data, the sample data including a mixed speech spectrum and a labeled phoneme thereof; extracting a target speech spectrum from the mixed speech spectrum by using a first subnetwork; adaptively transforming the target speech spectrum by using a second subnetwork, to obtain an intermediate transition representation; performing phoneme recognition based on the intermediate transition representation by using a third subnetwork; and updating parameters of the first subnetwork, the second subnetwork, and the third subnetwork according to a result of the phoneme recognition and the labeled phoneme.

### CROSS-REFERENCE TO RELATED APPLICATIONS

This application is a continuation application of PCT Patent Application No. PCT/CN2020/110742, entitled “MAP SWITCHING METHOD AND APPARATUS, AND STORAGE MEDIUM AND DEVICE” filed on Aug. 24, 2020, which claims priority to Chinese Patent Application No. 201910838469.5, entitled “SPEECH RECOGNITION METHOD AND APPARATUS, AND NEURAL NETWORK TRAINING METHOD AND APPARATUS” filed with the China National Intellectual Property Administration on Sep. 5, 2019, all of which are incorporated herein by reference in their entirety.

### FIELD OF THE TECHNOLOGY

This application relates to the field of artificial intelligence (AI) technologies, and specifically, to a neural network training method for implementing speech recognition, a neural network training apparatus for implementing speech recognition, a speech recognition method, a speech recognition apparatus, an electronic device, and a computer-readable storage medium.

### BACKGROUND OF THE DISCLOSURE

With the development of science and technology and the substantial improvement in hardware calculation capabilities, at present, speech recognition is implemented based on the deep learning technology an increasing quantity of times.

However, the implementation of speech recognition in acoustic scenarios is usually limited by the variability of the acoustic scenarios. For example, a case in which a monophonic voice signal is interfered with by non-stationary noise, such as background music or multi-speaker interference, is common in actual application scenarios.

Although the introduction of the deep learning technology brings large performance improvements to speech recognition technologies, performance of conventional speech recognition technologies in complex environments still needs to be optimized. For example, conventional speech recognition technologies often divide the phoneme separation/enhancement and phoneme recognition into different stages and treat them separately. This divide-and-conquer approach may introduce distortion and error into the acoustic model used for speech recognition.

The information disclosed in the above background part is only used for enhancing the understanding of the background of this application. Therefore, information that does not constitute the related art known to a person of ordinary skill in the art may be included.

### SUMMARY

An objective of embodiments of this application is to provide a neural network training method for implementing speech recognition, a neural network training apparatus for implementing speech recognition, a speech recognition method, a speech recognition apparatus, an electronic device, and a computer-readable storage medium, thereby improving speech recognition performance under complex interference sound conditions.

According to an aspect of this application, a neural network training method for implementing speech recognition is provided, performed by an electronic device, the neural network including a first subnetwork, a second subnetwork, and a third subnetwork, the method including:

obtaining sample data, the sample data including a mixed speech spectrum and a labeled phoneme thereof;

extracting a target speech spectrum from the mixed speech spectrum by using the first subnetwork;

adaptively transforming the target speech spectrum by using the second subnetwork, to obtain an intermediate transition representation;

performing phoneme recognition based on the intermediate transition representation by using the third subnetwork; and

updating parameters of the first subnetwork, the second subnetwork, and the third subnetwork according to a result of the phoneme recognition and the labeled phoneme by:

determining a joint loss function of the first subnetwork, the second subnetwork, and the third subnetwork;

calculating a value of the joint loss function according to the result of the phoneme recognition, the labeled phoneme, and the joint loss function; and

updating the parameters of the first subnetwork, the second subnetwork, and the third subnetwork according to the value of the joint loss function.

According to an aspect of this application, an electronic device is provided, including: a processor; and a memory, configured to store executable instructions of the processor; the processor being configured to execute the executable instructions to perform the neural network training method or the speech recognition method.

According to an aspect of this application, a non-transitory computer-readable storage medium is provided, storing executable instructions, the executable instructions, when executed by a processor of an electronic device, implementing the neural network training method or the speech recognition method.

It is to be understood that, the foregoing general descriptions and the following detailed descriptions are merely for illustration and explanation purposes and are not intended to limit this application.

### BRIEF DESCRIPTION OF THE DRAWINGS

Accompanying drawings herein are incorporated into a specification and constitute a part of this specification, show embodiments that conform to this application, and are used for describing a principle of this application together with this specification. Obviously, the accompanying drawings in the following descriptions are merely some embodiments of this application, and a person of ordinary skill in the art may further obtain other accompanying drawings according to the accompanying drawings without creative efforts.

FIG. 1 is a schematic diagram of an exemplary system architecture to which a neural network training method and apparatus according to embodiments of this application are applicable.

FIG. 2 is a schematic structural diagram of a computer system adapted to implement an electronic device according to an embodiment of this application.

FIG. 3 is a schematic flowchart of a neural network training method according to an embodiment of this application.

FIG. 4 is a schematic flowchart of a process of extracting a target speech spectrum according to an embodiment of this application.

FIG. 5 is a schematic signal flow diagram of a long short-term memory (LSTM) unit according to an embodiment of this application.

FIG. 6 is a schematic flowchart of generating hidden state information of a current transformation process according to an embodiment of this application.

FIG. 7 is a schematic flowchart of a process of performing phoneme recognition according to an embodiment of this application.

FIG. 8 is a schematic flowchart of a speech recognition method according to an embodiment of this application.

FIG. 9 is a schematic architecture diagram of an automatic speech recognition system according to an embodiment of this application.

FIG. 10A is a schematic reference diagram of a recognition effect of an automatic speech recognition system according to an embodiment of this application.

FIG. 10B is a schematic reference diagram of a recognition effect of an automatic speech recognition system according to an embodiment of this application.

FIG. 11 is a schematic block diagram of a neural network training apparatus according to an embodiment of this application.

FIG. 12 is a schematic block diagram of a speech recognition apparatus according to an embodiment of this application.

### DESCRIPTION OF EMBODIMENTS

Exemplary implementations are now described more comprehensively with reference to the accompanying drawings. However, the exemplary implementations can be implemented in various forms and are not construed as being limited to the examples herein. Conversely, such implementations are provided to make this application more comprehensive and complete, and fully convey the concepts of the exemplary implementations to a person skilled in the art. The described features, structures, or characteristics may be combined in one or more implementations in any appropriate manner. In the following description, many specific details are provided to give a full understanding of the implementations of this application. However, it is to be appreciated by a person skilled in the art that one or more of the specific details may be omitted during practice of the technical solutions of this application, or other methods, components, apparatus, steps, or the like may be used. In other cases, well-known technical solutions are not shown or described in detail to avoid overwhelming the subject and thus obscuring various aspects of this application.

In addition, the accompanying drawings are only schematic illustrations of this application and are not necessarily drawn to scale. The same reference numbers in the accompanying drawings represent the same or similar parts, and therefore, repeated descriptions thereof are omitted. Some of the block diagrams shown in the accompanying drawings are functional entities and do not necessarily correspond to physically or logically independent entities. The functional entities may be implemented in the form of software, or implemented in one or more hardware modules or integrated circuits, or implemented in different networks and/or processor apparatuses and/or micro-controller apparatuses.

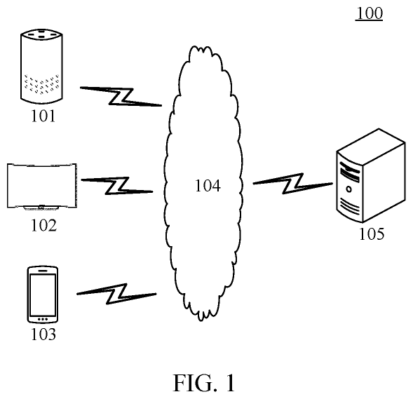

FIG. 1 is a schematic diagram of a system architecture of an exemplary application environment to which a neural network training method and apparatus for implementing speech recognition, and a speech recognition method and apparatus according to embodiments of this application are applicable.

As shown in FIG. 1, a system architecture 100 may include one or more of terminal devices 101, 102, and 103, a network 104, and a server 105. The network 104 is a medium configured to provide communication links between the terminal devices 101, 102, and 103, and the server 105. The network 104 may include various connection types, for example, a wired or wireless communication link, or an optical fiber cable. The terminal devices 101, 102, and 103 may include, but are not limited to, a smart speaker, a smart television, a smart television box, a desktop computer, a portable computer, a smartphone, a tablet computer, and the like. It is to be understood that the quantities of terminal devices, networks, and servers in FIG. 1 are merely exemplary. There may be any quantities of terminal devices, networks, and servers according to an implementation requirement. For example, the server 105 may be a server cluster including a plurality of servers.

The neural network training method or the speech recognition method provided in the embodiments of this application may be performed by the server 105, and correspondingly, a neural network training apparatus or a speech recognition apparatus may be disposed in the server 105. The neural network training method or the speech recognition method provided in the embodiments of this application may alternatively be performed by the terminal devices 101, 102, and 103, and correspondingly, a neural network training apparatus or a speech recognition apparatus may alternatively be disposed in the terminal devices 101, 102, and 103. The neural network training method or the speech recognition method provided in the embodiments of this application may further be performed by the terminal devices 101, 102, and 103 and the server 105 together, and correspondingly, the neural network training apparatus or the speech recognition apparatus may be disposed in the terminal devices 101, 102, and 103 and the server 105, which is not particularly limited in this exemplary embodiment.

For example, in an exemplary embodiment, after obtaining to-be-recognized mixed speech data, the terminal devices 101, 102, and 103 may encode the to-be-recognized mixed speech data and transmit the to-be-recognized mixed speech data to the server 105. The server 105 decodes the received mixed speech data and extracts a spectrum feature of the mixed speech data, to obtain a mixed speech spectrum, and then extracts a target speech spectrum from the mixed speech spectrum by using a first subnetwork, adaptively transforms the target speech spectrum by using a second subnetwork to obtain an intermediate transition representation, and performs phoneme recognition based on the intermediate transition representation by using a third subnetwork. After the recognition is completed, the server 105 may return a recognition result to the terminal devices 101, 102, and 103.

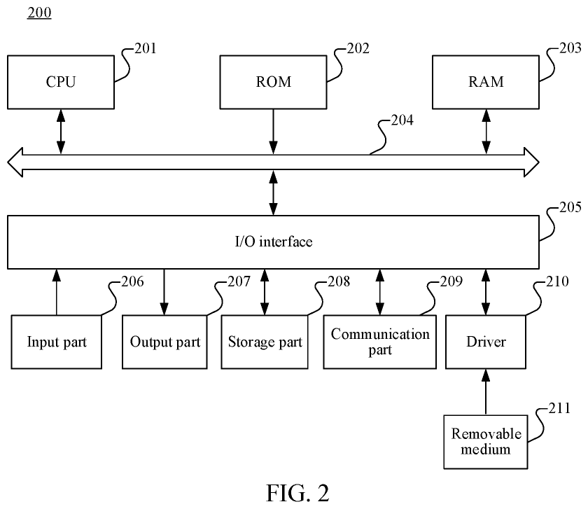

FIG. 2 is a schematic structural diagram of a computer system adapted to implement an electronic device according to an embodiment of this application. A computer system 200 of the electronic device shown in FIG. 2 is merely an example, and does not constitute any limitation on functions and use ranges of the embodiments of this application.

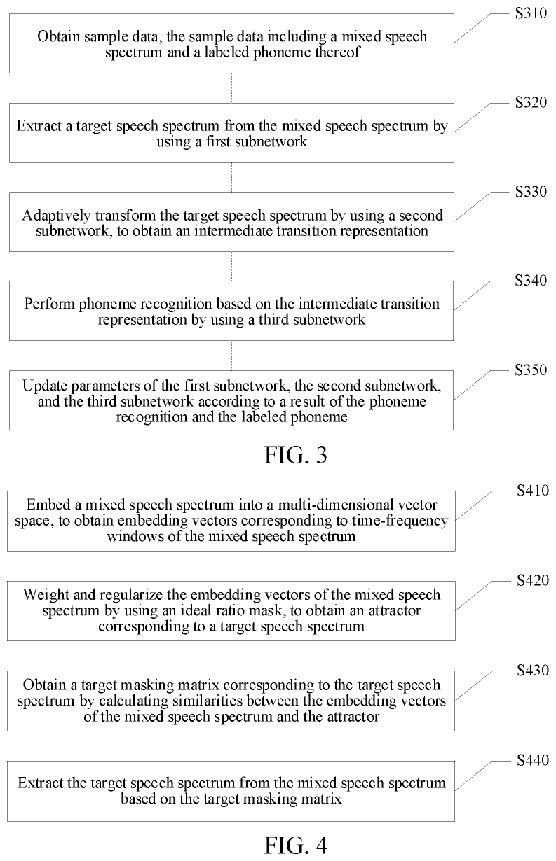

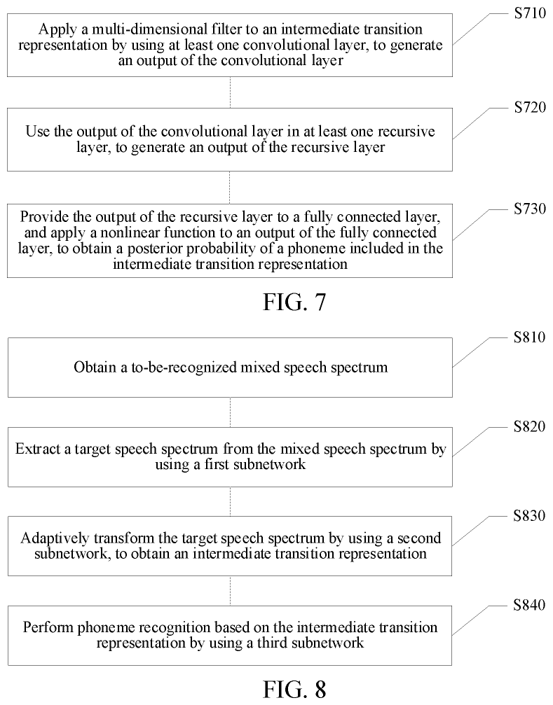

As shown in FIG. 2, the computer system 200 includes a central processing unit (CPU) 201, which can perform various appropriate actions and processing such as the methods described in FIG. 3, FIG. 4, FIG. 6, FIG. 7, and FIG. 8 according to a program stored in a read-only memory (ROM) 202 or a program loaded into a random access memory (RAM) 203 from a storage part 208. The RAM 203 further stores various programs and data required for operating the system. The CPU 201, the ROM 202, and the RAM 203 are connected to each other through a bus 204. An input/output (I/O) interface 205 is also connected to the bus 204.

The following components are connected to the I/O interface 205: an input part 206 including a keyboard, a mouse, or the like; an output part 207 including a cathode ray tube (CRT), a liquid crystal display (LCD), a speaker, or the like; a storage part 208 including a hard disk or the like; and a communication part 209 of a network interface card, including a LAN card, a modem, or the like. The communication part 209 performs communication processing via a network such as the Internet. A driver 210 is also connected to the I/O interface 205 as needed. A removable medium 211, such as a magnetic disk, an optical disk, a magneto-optical disk, a semiconductor memory, or the like, is installed on the drive 210 as needed, so that a computer program read therefrom is installed into the storage part 208 as needed.

Particularly, according to the embodiments of this application, the processes described in the following by referring to the flowcharts may be implemented as computer software programs. For example, the embodiments of this application include a computer program product, the computer program product includes a computer program carried on a computer-readable medium, and the computer program includes program code used for performing the methods shown in the flowcharts. In such an embodiment, the computer program may be downloaded and installed from the network through the communication part 209, and/or installed from the removable medium 211. When the computer program is executed by the CPU 201, various functions defined in the method and apparatus of this application are executed. In some embodiments, the computer system 200 may further include an AI processor. The AI processor is configured to process computing operations related to machine learning.

AI is a theory, method, technology, and application system that uses a digital computer or a machine controlled by a digital computer to simulate, extend, and expand human intelligence, perceive the environment, acquire knowledge, and use knowledge to obtain an optimal result. In other words, AI is a comprehensive technology of computer sciences, attempts to understand essence of intelligence, and produces a new intelligent machine that can react in a manner similar to human intelligence. AI is to study design principles and implementation methods of various intelligent machines, to enable the machines to have functions of perception, reasoning, and decision-making.

The AI technology is a comprehensive discipline and relates to a wide range of fields including both hardware-level technologies and software-level technologies. Basic AI technologies generally include technologies such as a sensor, a dedicated AI chip, cloud computing, distributed storage, a big data processing technology, an operating/interaction system, and electromechanical integration. AI software technologies mainly include several major directions such as a computer vision technology, a speech processing technology, a natural language processing technology, and machine learning/deep learning.

Key technologies of the speech processing technology include an automatic speech recognition (ASR) technology, a text-to-speech (TTS) technology, and a voiceprint recognition technology. To make a computer capable of listening, seeing, speaking, and feeling is the future development direction of human-computer interaction, and speech has become one of the most promising human-computer interaction methods in the future.

The technical solutions in this application relate to the speech processing technology. The technical solutions of the embodiments of this application are described in detail in the following.

Recognition of a mixed speech usually includes a speech separation stage and a phoneme recognition stage. In the related art, a cascaded framework including a speech separation model and a phoneme recognition model is provided, thereby allowing modular studies to be performed on the two stages independently. In such a modularization method, the speech separation model and the phoneme recognition model are trained respectively in a training stage. However, the speech separation model inevitably introduces signal errors and signal distortions in a processing process, and the signal errors and signal distortions are not considered in a process of training the phoneme recognition model. As a result, speech recognition performance of the cascaded framework is sharply degraded.

Based on the foregoing problem, one of the solutions provided by the inventor is to jointly train the speech separation model and the phoneme recognition model, which can significantly reduce a recognition error rate in noise robust speech recognition and multi-speaker speech recognition tasks. The following examples are provided:

In a technical solution provided by the inventor, an independent framework is provided, so that the speech separation stage is directly operated in a Mel filter domain, so as to be consistent with the phoneme recognition stage in a feature domain. However, because generally, the speech separation stage is not implemented in the Mel filter domain, this technical solution may result in a failure in obtaining a better speech separation result. In addition, with the continuous progress and development of speech separation algorithms, it is difficult for an independent framework to quickly and flexibly integrate a third-party algorithm. In another technical solution provided by the inventor, a joint framework is provided, where a deep neural network (DNN) is used to learn a Mel filter to affine a transformation function frame by frame. However, in the method, it is difficult to effectively model complex dynamic problems, and further, it is difficult to handle a speech recognition task under complex interference sound conditions.

Based on the one or more problems, this exemplary implementation provides a neural network training method for implementing speech recognition. The neural network training method may be applied to the server 105, or may be applied to one or more of the terminal devices 101, 102, and 103. As shown in FIG. 3, the neural network training method for implementing speech recognition may include the following steps.

Step S310. Obtain sample data, the sample data including a mixed speech spectrum and a labeled phoneme thereof.

Step S320. Extract a target speech spectrum from the mixed speech spectrum by using a first subnetwork.

Step S330. Adaptively transform the target speech spectrum by using a second subnetwork, to obtain an intermediate transition representation.

Step S340. Perform phoneme recognition based on the intermediate transition representation by using a third subnetwork.

Step S350. Update parameters of the first subnetwork, the second subnetwork, and the third subnetwork according to a result of the phoneme recognition and the labeled phoneme.

In the method provided in this exemplary implementation, the target speech spectrum extracted by using the first subnetwork is adaptively transformed by using the second subnetwork, to obtain the intermediate transition representation that may be inputted to the third subnetwork for phoneme recognition, so as to complete bridging of the speech separation stage and the phoneme recognition stage, to implement an end-to-end speech recognition system. On this basis, the first subnetwork, the second subnetwork, and the third subnetwork are jointly trained, to reduce impact of signal errors and signal distortions introduced in the speech separation stage on performance of the phoneme recognition stage. Therefore, in the method provided in this exemplary implementation, the speech recognition performance under the complex interference sound conditions may be improved to improve user experience. In addition, the first subnetwork and the third subnetwork in this exemplary implementation can easily integrate the third-party algorithm and have higher flexibility.

In another embodiment, the above steps are described more specifically below.

Step S310. Obtain sample data, the sample data including a mixed speech spectrum and a labeled phoneme thereof.

In this exemplary implementation, a plurality of sets of sample data may be first obtained, and each set of sample data may include a mixed speech and a labeled phoneme for the mixed speech. The mixed speech may be a speech signal that is interfered with by non-stationary noise such as background music or multi-speaker interference, resulting in occurrence of voice aliasing of different sound sources. Consequently, a received speech is a mixed speech. Labeled phonemes of the mixed speech indicate which phonemes are included in the mixed speech. A phoneme labeling method may be a manual labeling method, or a historical recognition result may be used as the labeled phoneme, which is not particularly limited in this exemplary embodiment. In addition, the each set of sample data may further include a reference speech corresponding to the mixed speech. The reference speech may be, for example, a monophonic voice signal received when a speaker speaks in a quiet environment or in a stationary noise interference environment. Certainly, the reference speech may alternatively be pre-extracted from the mixed speech by using another method such as clustering.

After obtaining the mixed speech and the reference speech, the mixed speech and the reference speech may be framed according to a specific frame length and a frame shift, to obtain speech data of the mixed speech in each frame and speech data of the reference speech in each frame. Next, a spectrum feature of mixed speech data and a spectrum feature of reference speech data may be extracted. For example, in this exemplary implementation, the spectrum feature of the mixed speech data and the spectrum feature of the reference speech data may be extracted based on a short-time Fourier transform (STFT) or another manner.

For example, in this exemplary implementation, mixed speech data of the n^{th} frame may be represented as x(n), and the mixed speech data x(n) may be considered as a linear superposition of target speech data ŝₛ(n) and interference speech data s_{I}(n), that is x(n)=ŝₛ(n)+s_{I}(n), and the reference speech data may be represented as sₛ(n). After the STFT is performed on the mixed speech data x(n) and the reference speech data sₛ(n), a logarithm of a result of the STFT is taken, to obtain the spectrum features of the mixed speech data and reference speech data. For example, a mixed speech spectrum corresponding to the mixed speech data is represented as a T×F-dimensional vector x, and a reference speech spectrum corresponding to the mixed speech data is represented as a T×F-dimensional vector sₛ, T being a total quantity of frames, and F being a quantity of frequency bands per frame.

Step S320. Extract a target speech spectrum from the mixed speech spectrum by using a first subnetwork.

In this exemplary implementation, an example in which the target speech spectrum is extracted by using a method based on an ideal ratio mask (IRM) is used for description. However, this exemplary implementation is not limited thereto. In other exemplary implementations of this application, the target speech spectrum may alternatively be extracted by using other methods. Referring to FIG. 4, in this exemplary implementation, the target speech spectrum may be extracted through the following steps S410 to S440.

Step S410. Embed the mixed speech spectrum into a multi-dimensional vector space, to obtain embedding vectors corresponding to time-frequency windows of the mixed speech spectrum.

For example, in this exemplary implementation, the mixed speech spectrum may be embedded into a K-dimensional vector space by using a DNN model. For example, the foregoing DNN may include a plurality of layers of bidirectional LSTM (BiLSTM) networks, for example, four layers of BiLSTM networks of a peephole connection. Each layer of BiLSTM network may include 600 hidden nodes. Certainly, the DNN may alternatively be replaced with various other effective network models, for example, a model obtained by combining a convolutional neural network (CNN) and another network structure, or another model such as a time delay network or a gated CNN. A model type and a topology of the DNN are not limited in this application.

Using a BiLSTM network as an example, the BiLSTM network can map the mixed speech spectrum from a vector space [symbol] ^{TF} to a higher-dimensional vector space [symbol] ^{TF×K} Specifically, an obtained embedding matrix V of the mixed speech spectrum is as follows:

V=φ_{BiLSTM}(x;Θ_{extract})∈ [symbol] ^{TF×K}

where Θ_{extract} represents a network parameter of a BiLSTM network φ_{BiLSTM}( ), and an embedding vector corresponding to each time-frequency window is V_{f,t}, where t∈[1, T], and f∈[1, F].

Step S420. Weight and regularize the embedding vectors of the mixed speech spectrum by using an IRM, to obtain an attractor corresponding to the target speech spectrum.

For example, in this exemplary implementation, the IRM mₛ may be calculated through |sₛ|/|x|, and then, the IRM mₛ may be used to weight and regularize the embedding vectors of the mixed speech spectrum, to obtain an attractor aₛ corresponding to the target speech spectrum, where the attractor aₛ∈ [symbol] ^{K}. In addition, to remove noise of a low-energy spectrum window to obtain an effective frame, in this exemplary implementation, a supervision label w may further be set, where the supervision label w∈ [symbol] ^{TF}. By using the supervision label w, a spectrum of each frame of the speech spectrum can be compared with a spectrum threshold. If a spectrum amplitude of a specific frame of the speech spectrum is less than the spectrum threshold, a value of a supervision label of the frame of the spectrum is 0; otherwise, the value is 1. Using an example in which a spectrum threshold is max (x)/100, the supervision label w may be as follows:

$${w}_{t , f} = \{ \begin{matrix}0 , if {x}_{t , f} < max ( x ) / 100 \\ 1 , else\end{matrix} \qquad$$

Correspondingly, the attractor aₛ corresponding to the target speech spectrum may be as follows:

$${a}_{s} = \frac{{V}^{T} ( {m}_{s} ⊙ w )}{{{\sum }_{t = 1}}^{T} {{\sum }_{f = 1}}^{F} ( {m}_{s} ⊙ w )}$$

where ⊙ represents an element multiplication of a matrix.

Step S430. Obtain a target masking matrix corresponding to the target speech spectrum by calculating similarities between the embedding vectors of the mixed speech spectrum and the attractor.

For example, in this exemplary implementation, distances between the embedding vectors of the mixed speech and the attractor can be calculated, and values of the distances are mapped into a range of [0, 1], to represent the similarities between the embedding vectors and the attractor. For example, the similarities between the embedding vectors V_{f,t} of the mixed speech and the attractor aₛ are calculated through the following formula, to obtain a target masking matrix \hat{m}ₛ corresponding to the target speech spectrum:

\hat{m}ₛ=Sigmoid(Vaₛ)

Sigmoid is a sigmoid function and can map a variable to the range of [0, 1], thereby facilitating the subsequent extraction of the target speech spectrum. In addition, in other exemplary implementations of this application, the similarities between the embedding vectors of the mixed speech and the attractor may be calculated based on a tan h function or another manner, and the target masking matrix corresponding to the target speech spectrum is obtained, which also belongs to the protection scope of this application.

Step S440. Extract the target speech spectrum from the mixed speech spectrum based on the target masking matrix.

In this exemplary implementation, the mixed speech spectrum x may be weighted by using the target masking matrix \hat{m}ₛ, to extract the target speech spectrum in the mixed speech spectrum time-frequency window by time-frequency window. For a mixed speech spectrum x_{f,t} of a specific time-frequency window, a greater target masking matrix indicates that more spectrum information corresponding to the time-frequency window is extracted. For example, the target speech spectrum ŝₛ may be extracted through the following formula:

ŝₛ=x⊙\hat{m}ₛ

In addition, in this exemplary implementation, attractors calculated during training based on sets of sample data may further be obtained, and a mean value of the attractors is calculated to obtain a global attractor used for extracting the target speech spectrum during a test phase.

Step S330. Adaptively transform the target speech spectrum by using a second subnetwork, to obtain an intermediate transition representation.

In this exemplary implementation, the second subnetwork is used for bridging the foregoing first subnetwork and the following third subnetwork, an input of the second subnetwork is a target speech spectrum (hereinafter denoted as S, S={S₁, S₂, . . . , S_{T}}) extracted by the first subnetwork, and a final training objective of the intermediate transition representation outputted by the second subnetwork is to minimize a recognition loss of the third subnetwork. Based on this, in this exemplary implementation, target speech spectra of time-frequency windows are adaptively transformed according to a sequence of the time-frequency windows of the target speech spectrum. A process of transforming one of the time-frequency windows includes: generating hidden state information of a current transformation process according to a target speech spectrum of a time-frequency window targeted by the current transformation process and hidden state information of a previous transformation process; and obtaining, based on the hidden state information, an intermediate transition representation of the time-frequency window targeted by the current transformation process. The transformation process is described in detail below by using an LSTM network as an example.

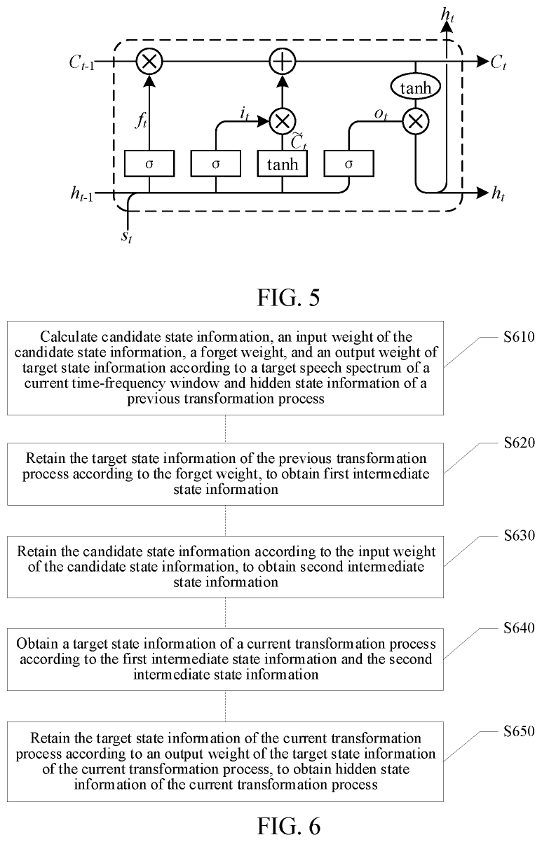

Referring to FIG. 5, the LSTM network is a processing unit (hereinafter referred to as an LSTM unit for short). The LSTM unit usually includes a forget gate, an input gate, and an output gate. In this exemplary implementation, the transformation process may be performed by using one LSTM unit. FIG. 6 is a process in which an LSTM unit generates hidden state information of a current transformation process, which may include the following steps S610 to S650.

Step S610. Calculate candidate state information, an input weight of the candidate state information, a forget weight of target state information of the previous transformation process, and an output weight of target state information of the current transformation process according to a target speech spectrum of a current time-frequency window and hidden state information of a previous transformation process. Details are as follows:

The forget gate is used for determining how much information is discarded from the target state information of the previous transformation process. Therefore, the forget weight is used for representing a weight of the target state information of the previous transformation process that is not forgotten (that is, can be retained). The forget weight may be substantially a weight matrix. For example, the target speech spectrum of the current time-frequency window and the hidden state information of the previous transformation process may be encoded by using an activation function used for representing the forget gate and mapped to a value between 0 and 1, to obtain the forget weight of the target state information of the previous transformation process, where 0 means being completely discarded, and 1 means being completely retained. For example, a forget weight fₜ of the target state information of the previous transformation process may be calculated according to the following formula:

fₜ=σ(W_{f}·[hₜ₋₁,Sₜ]+b_{f})

where hₜ₋₁ represents the hidden state information of the previous transformation process, Sₜ represents the target speech spectrum of the current time-frequency window, σ represents an activation function, that is, a Sigmoid function, W_{f} and b_{f} represent parameters of the Sigmoid function in the forget gate, and [hₜ₋₁, Sₜ] represents combining hₜ₋₁ and Sₜ.

The input gate is used for determining how much information is important and needs to be retained in the currently inputted target speech spectrum. For example, the target speech spectrum of the current time-frequency window and the hidden state information of the previous transformation process may be encoded by using an activation function representing the input gate, to obtain the candidate state information and the input weight of the candidate state information, the input weight of the candidate state information being used for determining how much new information in the candidate state information may be added to the target state information.

For example, the candidate state information \tilde{C}ₜ may be calculated according to the following formula:

Cₜ=tan h(W_{c}·[hₜ₋₁,Sₜ]+b_{c})

where tan h represents that the activation function is a hyperbolic tangent function, and W_{c} b_{c} represent parameters of the tan h function in the input gate.

An input weight iₜ of the candidate state information may be calculated according to the following formula:

iₜ=σ(Wᵢ·[hₜ₋₁,Sₜ]+bᵢ)

where σ represents the activation function, that is, the Sigmoid function, and Wᵢ bᵢ represent parameters of the Sigmoid function in the input gate.

The output gate is used for determining what information needs to be included in the hidden state information outputted to a next LSTM unit. For example, the target speech spectrum of the current time-frequency window and the hidden state information of the previous transformation process may be encoded by using an activation function representing the output gate, to obtain the output weight of the target state information of the current transformation process. For example, the candidate state information oₜ may be calculated according to the following formula:

o_{f}=σ(Wₒ·[hₜ₋₁,Sₜ]+bₒ)

where σ represents the activation function, that is, the Sigmoid function, and Wₒ bₒ represent parameters of the Sigmoid function in the output gate.

Step S620. Retain the target state information of the previous transformation process according to the forget weight, to obtain first intermediate state information. For example, the obtained first intermediate state information may be fₜ⊗Cₜ₋₁, Cₜ₋₁ representing the target state information of the previous transformation process.

Step S630. Retain the candidate state information according to the input weight of the candidate state information, to obtain second intermediate state information. For example, the obtained second intermediate state information may be iₜ⊗\tilde{C}ₜ.

Step S640. Obtain the target state information of the current transformation process according to the first intermediate state information and the second intermediate state information. For example, the target state information of the current transformation process is Cₜ=fₜ⊗Cₜ₋₁+iₜ⊗\tilde{C}ₜ.

Step S650. Retain the target state information of the current transformation process according to the output weight of the target state information of the current transformation process, to obtain the hidden state information of the current transformation process. For example, the hidden state information of the current transformation process is hₜ=oₜ⊗ tan h(Cₜ).

Further, in the foregoing adaptive transformation, target speech spectra of time-frequency windows are adaptively transformed in sequence to obtain hidden state information hₜ, that is, adaptive transformation performed by using a forward LSTM. In this exemplary implementation, adaptive transformation may alternatively be performed by using a BiLSTM network. Still further, in other exemplary embodiments, adaptive transformation may alternatively be performed by using a plurality of layers of BiLSTM networks of a peephole connection, thereby further improving accuracy of the adaptive transformation. For example, based on the foregoing adaptive transformation process, the target speech spectra of the time-frequency windows are adaptively transformed in reverse sequence to obtain hidden state information \tilde{h}ₜ, and the hidden state information hₜ is spliced with the hidden state information \tilde{h}ₜ to obtain an output of the BiLSTM network, that is, hidden state information Hₜ, so as to better represent a bidirectional timing dependence feature by using the hidden state information Hₜ.

To enable the hidden state information Hₜ to better adapt to the subsequent third subnetwork, in this exemplary implementation, one or more of the following processing may be performed on each piece of hidden state information, to obtain the intermediate transition representation of the time-frequency window targeted by the current transformation process. The following examples are provided:

In a standard computing process of a thank feature, an inputted frequency spectrum is squared, so that the thank feature obtained is definitely non-negative. To match non-negativity of the thank feature, in this exemplary implementation, the output of the BiLSTM network can be squared, thereby implementing non-negative mapping. In addition, in other exemplary embodiments of this application, non-negative mapping may alternatively be implemented by using a rectified linear unit (ReLU) function or another manner, which is not particularly limited in this exemplary embodiment. For example, a non-negative mapping result may be as follows:

\hat{f}=φ_{BiLSTM}(S;Θ_{adapt})²∈ [symbol] ₊^{TD}

where D represents a dimension of the intermediate transition representation, and Θ_{adapt} represents a network parameter of a BiLSTM network φ_{BiLSTM}( ).

After the non-negative mapping is performed, a series of differentiable operations such as element-wise logarithm finding, calculation of a difference first-order difference, and calculation of a second-order difference may further be performed on \hat{f}. In addition, alternatively, global mean variance normalization may be performed, and features of a previous time-frequency window and a next time-frequency window are added. For example, for a current time-frequency window, a feature of the current time-frequency window, features of W time-frequency windows before the current time-frequency window, and features of W time-frequency windows after the current time-frequency window, that is, features of a total of 2W+1 time-frequency windows are spliced, to obtain an intermediate transition representation of the current time-frequency window, and an intermediate transition representation f∈ [symbol] ₊^{3D(2W+1)} is obtained after the foregoing processing. In other exemplary embodiments of this application, a part of the processing process may alternatively be selected from the foregoing processing process for execution, and other manners may alternatively be selected for processing, which also belong to the protection scope of this application.

Step S340. Perform phoneme recognition based on the intermediate transition representation by using a third subnetwork.

In this exemplary implementation, the intermediate transition representation f outputted by the second subnetwork may be inputted to the third subnetwork, to obtain a posterior probability [symbol] ₜ of a phoneme included in the intermediate transition representation. For example, the third subnetwork may be a convolutional long and short-term memory deep neural network (CLDNN) based on an optimal center loss, which is may be denoted as a CL_CLDNN network below. After the intermediate transition representation f is inputted to the CL_CLDNN network, operations shown in the following formulas may be performed:

U=φ_{CL_CLDNN}(f;Γ)

[symbol]

ₜ=Softmax(Wuₜ+b)

where uₜ is an output of the t^{th} frame of the penultimate layer (for example, the penultimate layer of a plurality of fully connected layers described below) of the CL_CLDNN network, Softmax(z)=e^{z}/∥e^{z}∥₁ may be used for calculating the posterior probability of the phoneme, and Θ_{recog}={Γ,W,b} represents a parameter of the CL_CLDNN network.

A specific processing process of the CL_CLDNN network is described below. Referring to FIG. 7, the third subnetwork may perform phoneme recognition based on the intermediate transition representation through the following steps S710 to S730.

Step S710. Apply a multi-dimensional filter to the intermediate transition representation by using at least one convolutional layer, to generate an output of the convolutional layer, so as to reduce a spectrum difference. For example, in this exemplary implementation, two convolutional layers may be included, and each convolutional layer may include 256 feature maps. A 9×9 time domain-frequency domain filter may be used at the first convolutional layer, and a 4×3 time domain-frequency domain filter may be used at the second conventional layer. In addition, because an output dimension of the last convolutional layer may be very large, in this exemplary implementation, a linear layer may be connected after the last convolutional layer for dimension reduction.

Step S720. Use the output of the convolutional layer in at least one recursive layer, to generate an output of the recursive layer. For example, in this exemplary implementation, the recursive layer may include a plurality of layers of LSTM networks, for example, two layers of LSTM networks may be connected after the linear layer, and each LSTM network may use 832 processing units and 512-dimensional mapping layers for dimension reduction. In other exemplary embodiments of this application, the recursive layer may alternatively include, for example, a gated recurrent unit (GRU) network or another recurrent neural network (RNN) network structure, which is not particularly limited in this exemplary embodiment.

Step S730. Provide the output of the recursive layer to at least one fully connected layer, and apply a nonlinear function to an output of the fully connected layer, to obtain a posterior probability of a phoneme included in the intermediate transition representation. In this exemplary implementation, the fully connected layer may be, for example, a two-layer DNN structure. Each DNN structure may include 1024 neurons, and through the DNN structure, a feature space may be mapped to an output layer that is easier to be classified. The output layer may be classified by using a nonlinear function such as the Softmax function or the tan h function, to obtain the posterior probability of the phoneme included in the intermediate transition representation.

Step S350. Update parameters of the first subnetwork, the second subnetwork, and the third subnetwork according to a result of the phoneme recognition and the labeled phoneme.

For example, in this exemplary implementation, a joint loss function of the first subnetwork, the second subnetwork, and the third subnetwork may be first determined. For example, in this exemplary implementation, the center loss and a cross-entropy loss may be used as the joint loss function. Certainly, in other exemplary embodiments of this application, other losses may alternatively be used as the joint loss function, and this exemplary embodiment is not limited thereto.

After the joint loss function is determined, the result of the phoneme recognition and the labeled phoneme may be inputted to the joint loss function, and a value of the joint loss function is calculated. After the value of the joint loss function is obtained, the parameters of the first subnetwork, the second subnetwork, and the third subnetwork are updated according to the value of the joint loss function. For example, a training objective may be to minimize the value of the joint loss function, and the parameters of the first subnetwork, the second subnetwork, and the third subnetwork are updated by using the methods such as stochastic gradient decent (SGD) and back propagation (BP) until convergence, for example, a quantity of training iterations reaches a maximum quantity of times or the value of the joint loss function no longer decreases.

This exemplary implementation further provides a speech recognition method based on a neural network, and the neural network may be obtained through training by using the training method in the foregoing exemplary embodiment. The speech recognition method may be applied to one or more of the terminal devices 101, 102, and 103, or may be applied to the server 105. Referring to FIG. 8, the speech recognition method may include the following steps S810 to S840.

Step S810. Obtain a to-be-recognized mixed speech spectrum.

In this exemplary implementation, mixed speech may be a speech signal that is interfered by non-stationary noise such as background music or multi-speaker interference, so that speech aliasing of different sources occurs, and received speech is the mixed speech. After obtaining the mixed speech, framing processing may be performed on the mixed speech according to a specific frame length and frame shift, to obtain speech data of the mixed speech in each frame. Next, a spectrum feature of mixed speech data may be extracted. For example, in this exemplary implementation, the spectrum feature of the mixed speech data may be extracted based on STFT or other manners.

For example, in this exemplary implementation, mixed speech data of the n^{th} frame may be represented as x(n), the mixed speech data x(n) may be considered as a linear superposition of target speech data ŝₛ(n) and interference speech data s_{I} (n), that is x(n)=ŝₛ(n)+s_{I}(n). After the STFT is performed on the mixed speech data x(n), a logarithm of a result obtained through the STFT is taken to obtain the spectrum features of the mixed speech data. For example, a mixed speech spectrum corresponding to the mixed speech data is represented as a T×F dimensional vector x, T being a total quantity of frames, and F being a quantity of frequency bands per frame.

Step S820. Extract a target speech spectrum from the mixed speech spectrum by using a first subnetwork.

In this exemplary implementation, an example in which the target speech spectrum is extracted by using a method based on an ideal ratio mask (IRM) is used for description. However, this exemplary implementation is not limited thereto. In other exemplary implementations of this application, the target speech spectrum may alternatively be extracted by using other methods. The following examples are provided:

First, the mixed speech spectrum is embedded into a multi-dimensional vector space, to obtain embedding vectors corresponding to time-frequency windows of the mixed speech spectrum. Using a BiLSTM network as an example, the BiLSTM network can map the mixed speech spectrum from a vector space [symbol] ^{TF} to a higher-dimensional vector space [symbol] ^{TF×K} Specifically, an obtained embedding matrix V of the mixed speech spectrum is as follows:

V=φ_{BiLSTM}(x;Θ_{extract})∈ [symbol] ^{TF×K}

where Θ_{extract} represents a network parameter of a BiLSTM network φ_{BiLSTM}( ), and an embedding vector corresponding to each time-frequency window is V_{f,t}, where t∈[1,T], and f∈[1,F].

Next, the global attractor āₛ obtained in step S320 in the foregoing training process is obtained, and a target masking matrix corresponding to the target speech spectrum is obtained by calculating similarities between the embedding vectors of the mixed speech and the global attractor. For example, the similarities between the embedding vectors V_{f,t} of the mixed speech and the global attractor āₛ are calculated through the following formula, to obtain a target masking matrix \hat{m}ₛ corresponding to the target speech spectrum:

\hat{m}ₛ=Sigmoid(Vāₛ)

Subsequently, the target speech spectrum is extracted from the mixed speech spectrum based on the target masking matrix. For example, the target speech spectrum ŝₛ may be extracted through the following formula:

ŝₛ=x⊙\hat{m}ₛ

Step S830. Adaptively transform the target speech spectrum by using a second subnetwork, to obtain an intermediate transition representation.

In this exemplary implementation, target speech spectra of time-frequency windows may be adaptively transformed according to a sequence of the time-frequency windows of the target speech spectrum, and a process of transforming one of the time-frequency windows may include: generating hidden state information of a current transformation process according to a target speech spectrum of a time-frequency window targeted by the current transformation process and hidden state information of a previous transformation process; and obtaining, based on the hidden state information, an intermediate transition representation of the time-frequency window targeted by the current transformation process. For example, in this exemplary implementation, the transformation process may be performed by using LSTM units of the BiLSTM network.

To match non-negativity of the thank feature, in this exemplary implementation, an output of the BiLSTM network can further be squared, thereby implementing non-negative mapping. For example, a non-negative mapping result may be as follows:

\hat{f}=φ_{BiLSTM}(S;Θ_{adapt})²∈ [symbol] ₊^{TD}

where D represents a dimension of the intermediate transition representation, and Θ_{adapt} represents a network parameter of a BiLSTM network φ_{BiLSTM}( ).

After the non-negative mapping is performed, a series of differentiable operations such as element-wise logarithm finding, calculation of a difference first-order difference, and calculation of a second-order difference may further be performed on \hat{f}. In addition, alternatively, global mean variance normalization may be performed, and features of a previous time-frequency window and a next time-frequency window are added. For example, for a current time-frequency window, a feature of the current time-frequency window, features of W time-frequency windows before the current time-frequency window, and features of W time-frequency windows after the current time-frequency window, that is, features of a total of 2W+1 time-frequency windows are spliced, to obtain an intermediate transition representation of the current time-frequency window, and an intermediate transition representation f∈ [symbol] ₊^{3D(2W+1)} is obtained after the foregoing processing.

Step S840. Perform phoneme recognition based on the intermediate transition representation by using a third subnetwork.

In this exemplary implementation, the intermediate transition representation f outputted by the second subnetwork may be inputted to the third subnetwork, to obtain a posterior probability [symbol] ₜ of a phoneme included in the intermediate transition representation. For example, the third subnetwork may be a CL_CLDNN network. After the intermediate transition representation f is inputted to the CL_CLDNN network, operations shown in the following formulas may be performed:

u=φ_{CL_CLDNN}(f;Γ)

[symbol]

ₜ=Softmax(Wuₜ+b)

where uₜ is an output of the t^{th} frame of the penultimate layer (for example, the penultimate layer of a plurality of fully connected layers described below) of the CL_CLDNN network, Softmax(z)=e^{z}/∥e^{z}∥₁ may be used for calculating the posterior probability of the phoneme, and Θ_{recog}={Γ,W,b} represents a parameter of the CL_CLDNN network.

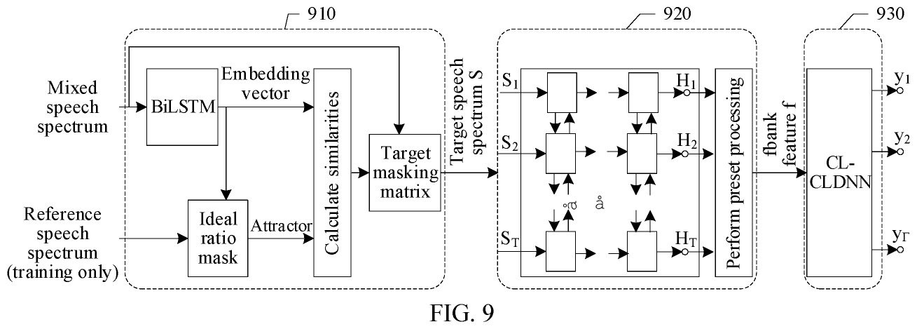

With reference to the implementation of the foregoing method, description is made by using an example in which an automatic speech recognition system is implemented below. Referring to FIG. 9, the automatic speech recognition system may include a first subnetwork 910, a second subnetwork 920, and a third subnetwork 930.

The first subnetwork 910 may be configured to extract a target speech spectrum from mixed speech spectrum. Referring to FIG. 9, the first subnetwork may include a plurality of layers (for example, four layers) of BiLSTM networks of a peephole connection, and each layer of the BiLSTM network may include 600 hidden nodes. Meanwhile, a fully connected layer may be connected after the last layer of the BiLSTM network to map 600-dimensional hidden state information into a 24,000-dimensional embedding vector. The mixed speech spectrum may be, for example, a 512-dimensional STFT spectrum feature with a sampling rate of 16,000 Hz, a frame length of 25 ms, and a frame shift of 10 ms. After the mixed speech spectrum is inputted to the first subnetwork 910, the mixed speech spectrum may be mapped to embedding vectors through the BiLSTM network, and then, similarities between the embedding vectors and an attractor may be calculated to obtain a target masking matrix, and further, a target speech spectrum S may be extracted from the mixed speech spectrum based on the target masking matrix. In a training stage, a reference speech spectrum may further be inputted to the first subnetwork 910, an IRM may be calculated according to the reference speech spectrum, and the embedding vectors of the mixed speech spectrum may be weighted and regularized according to the IRM, to obtain the attractor.

The second subnetwork 920 may be configured to adaptively transform the target speech spectrum, to obtain an intermediate transition representation. Referring to FIG. 9, the second subnetwork 920 may include a plurality of layers (for example, two layers) of BiLSTM networks of a peephole connection, and each layer of the BiLSTM network may include 600 hidden nodes. After the target speech spectrum S outputted by the first subnetwork is inputted to the BiLSTM network, hidden state information H, H={H₁, H₁, . . . , H_{T}} outputted by the BiLSTM network may be obtained. Next, preset processing, such as non-negative mapping, element-wise logarithm finding, calculation of a first-order difference, calculation of a second-order difference, global mean variance normalization, and addition of features of previous and next time-frequency windows, may be performed on the hidden state information H, to obtain the intermediate transition representation ƒ. In this exemplary implementation, the intermediate transition representation ƒ may be, for example, a 40-dimensional thank feature vector.

The third subnetwork 930 may be used for performing phoneme recognition based on the intermediate transition representation. Referring to FIG. 9, the third subnetwork 920 may include a CL_CLDNN network. After the intermediate transition representation f is inputted to the third subnetwork, a posterior probability [symbol] ₜ of a phoneme included in the intermediate transition representation may be obtained. Using Chinese Mandarin as an example, posterior probabilities of approximately 12,000 categories of phonemes may be outputted.

During specific training, a batch size of sample data may be set to 24, an initial learning rate α is set to 10⁻⁴, a decay coefficient of the learning rate is set to 0.8, a convergence determining condition is set to that a comprehensive loss function value is not improved in three consecutive iterations (epoch), a dimension K of the embedding vector is set to 40, a quantity D of Mel filter frequency bands is set to 40, a quantity W of time-frequency windows during addition of features of previous and next time-frequency windows is set to 5, and a weight λ of a center loss is set to 0.01. In addition, batch normalization may be performed on both a convolutional layer in the CL_CLDNN network and an output of an LSTM network, to implement faster convergence and better generalization.

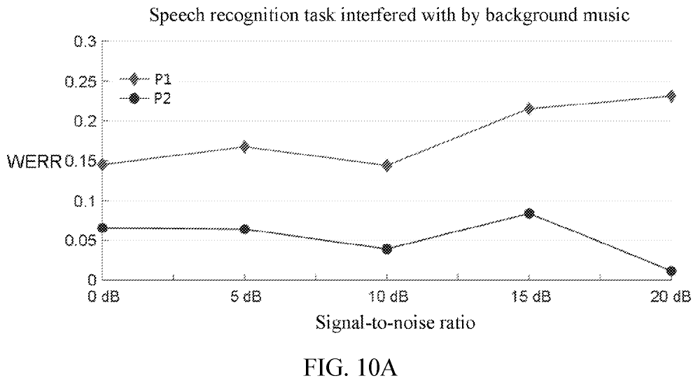

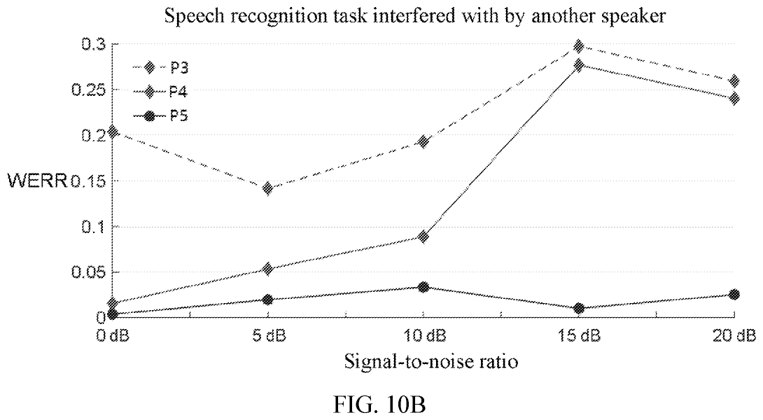

FIG. 10A and FIG. 10B are reference diagrams of a speech recognition effect of an automatic speech recognition system. FIG. 10A shows a speech recognition task interfered with by background music, and FIG. 10B is a speech recognition task interfered with by another speaker. In FIG. 10A and FIG. 10B, a vertical axis represents a recognition effect by using a relative word error rate reduction (WERR), and a horizontal axis represents signal-to-noise ratio interference test conditions of different decibels (dB), where there are a total of five signal-to-noise ratios: 0 dB, 5 dB, 10 dB, 15 dB, and 20 dB.

In FIG. 10A and FIG. 10B, a line P1 and a line P4 represent WERRs obtained by comparing the automatic speech recognition system with a baseline system in this exemplary implementation. A line P2 and a line P5 represent WERRs obtained by comparing an existing advanced automatic speech recognition system (for example, a robust speech recognition joint training architecture that uses a DNN to learn a Mel filter to affine a transformation function frame by frame) with the baseline system. A line P3 represents a WERR obtained by comparing the automatic speech recognition system in this exemplary implementation combined with target speaker tracking with the baseline system.

The existing advanced automatic speech recognition system is equivalent to the automatic speech recognition system in this exemplary implementation in terms of parameter complexity. However, it may be seen from FIG. 10A and FIG. 10B that in two recognition tasks, the WERR of the automatic speech recognition system in this exemplary implementation is significantly better than that of the existing advanced automatic speech recognition system, indicating that the automatic speech recognition system in this exemplary implementation can effectively model problems with temporal complexity, thereby further improving speech recognition performance under complex interference sound conditions.

In addition, in addition to the significant improvement in recognition performance, the automatic speech recognition system in this exemplary implementation also has a high degree of flexibility, for example, allowing flexible integration of various speech separation modules and phoneme recognition modules into a first subnetwork and a third subnetwork, and the automatic speech recognition system in this exemplary implementation is implemented without the cost of performance impairment of any individual module.

Therefore, the application of the automatic speech recognition system in this exemplary implementation to a plurality of projects and product applications including smart speakers, smart TVs, online speech recognition systems, smart speech assistants, simultaneous interpretation, and virtual people can significantly improve accuracy of automatic speech recognition, especially recognition performance in a complex interference environment, thereby improving user experience.

Although the steps of the method in this application are described in a specific order in the accompanying drawings, this does not require or imply that the steps have to be performed in the specific order, or all the steps shown have to be performed to achieve an expected result. Additionally or alternatively, some steps may be omitted, a plurality of steps may be combined into one step for execution, and/or one step may be decomposed into a plurality of steps for execution, and the like.

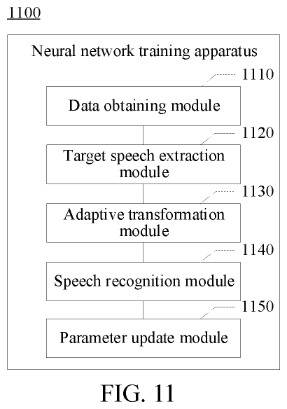

Further, in an exemplary implementation, a neural network training apparatus for implementing speech recognition is further provided. The neural network training apparatus may be applied not only to a server but also to a terminal device. The neural network includes a first subnetwork to a third subnetwork. Referring to FIG. 11, the neural network training apparatus 1100 may include a data obtaining module 1110, a target speech extraction module 1120, an adaptive transformation module 1130, a speech recognition module 1140, and a parameter update module 1150.

The data obtaining module 1110 may be configured to obtain sample data, the sample data including a mixed speech spectrum and a labeled phoneme thereof.

The target speech extraction module 1120 may be configured to extract a target speech spectrum from the mixed speech spectrum by using the first subnetwork.

The adaptive transformation module 1130 may be configured to adaptively transform the target speech spectrum by using the second subnetwork, to obtain an intermediate transition representation.

The speech recognition module 1140 may be configured to perform phoneme recognition based on the intermediate transition representation by using the third subnetwork.

The parameter update module 1150 may be configured to update parameters of the first subnetwork, the second subnetwork, and the third subnetwork according to a result of the phoneme recognition and the labeled phoneme.

In an exemplary embodiment of this application, the target speech extraction module 1120 extracts the target speech spectrum from the mixed speech spectrum through the following steps: embedding the mixed speech spectrum into a multi-dimensional vector space, to obtain embedding vectors corresponding to time-frequency windows of the mixed speech spectrum; weighting and regularizing the embedding vectors of the mixed speech spectrum by using an IRM, to obtain an attractor corresponding to the target speech spectrum; obtaining a target masking matrix corresponding to the target speech spectrum by calculating similarities between the embedding vectors of the mixed speech spectrum and the attractor; and extracting the target speech spectrum from the mixed speech spectrum based on the target masking matrix.

In an exemplary embodiment of this application, the apparatus further includes:

a global attractor computing module, configured to obtain attractors corresponding to the sample data, and calculating a mean value of the attractors, to obtain a global attractor.

In an exemplary embodiment of this application, the adaptive transformation module 1130 adaptively transforms the target speech spectrum through the following step: adaptively transforming target speech spectra of time-frequency windows in sequence according to a sequence of the time-frequency windows of the target speech spectrum, a process of transforming one of the time-frequency windows including:

generating hidden state information of a current transformation process according to a target speech spectrum of a time-frequency window targeted by the current transformation process and hidden state information of a previous transformation process; and obtaining, based on the hidden state information, an intermediate transition representation of the time-frequency window targeted by the current transformation process.

In an exemplary embodiment of this application, the adaptive transformation module 1130 generates the hidden state information of the current transformation process through the following steps: calculating candidate state information, an input weight of the candidate state information, a forget weight of target state information of the previous transformation process, and an output weight of target state information of the current transformation process according to a target speech spectrum of a current time-frequency window and the hidden state information of the previous transformation process; retaining the target state information of the previous transformation process according to the forget weight, to obtain first intermediate state information; retaining the candidate state information according to the input weight of the candidate state information, to obtain second intermediate state information; obtain the target state information of the current transformation process according to the first intermediate state information and the second intermediate state information; and retaining the target state information of the current transformation process according to the output weight of the target state information of the current transformation process, to obtain the hidden state information of the current transformation process.

In an exemplary embodiment of this application, the adaptive transformation module 1130 obtains, based on the hidden state information, an intermediate transition representation of the time-frequency window targeted by the current transformation process through the following step: performing one or more of the following processing on the hidden state information, to obtain the intermediate transition representation of the time-frequency window targeted by the current transformation process:

non-negative mapping, element-wise logarithm finding, calculation of a first-order difference, calculation of a second-order difference, global mean variance normalization, and addition of features of previous and next time-frequency windows.

In an exemplary embodiment of this application, the speech recognition module 1140 performs phoneme recognition based on the intermediate transition representation through the following steps: applying a multi-dimensional filter to the intermediate transition representation by using at least one convolutional layer, to generate an output of the convolutional layer; using the output of the convolutional layer in at least one recursive layer, to generate an output of the recursive layer; and providing the output of the recursive layer to at least one fully connected layer, and applying a nonlinear function to an output of the fully connected layer, to obtain a posterior probability of a phoneme included in the intermediate transition representation.

In an exemplary embodiment of this application, the recursive layer includes an LSTM network.

In an exemplary embodiment of this application, the parameter update module 1150 updates the parameters of the first subnetwork, the second subnetwork, and the third subnetwork through the following steps: determining a joint loss function of the first subnetwork, the second subnetwork, and the third subnetwork; calculating a value of the joint loss function according to the result of the phoneme recognition, the labeled phoneme, and the joint loss function; and updating the parameters of the first subnetwork, the second subnetwork, and the third subnetwork according to the value of the joint loss function.

In an exemplary embodiment of this application, the first subnetwork includes a plurality of layers of LSTM networks of a peephole connection, and the second subnetwork includes a plurality of layers of LSTM networks of a peephole connection.

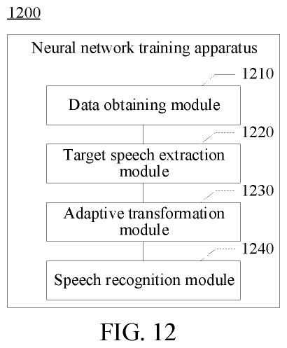

Further, in this exemplary implementation, a speech recognition apparatus based on a neural network is further provided. The speech recognition apparatus may be applied not only to a server but also to a terminal device. The neural network includes a first subnetwork to a third subnetwork. Referring to FIG. 12, the neural network training apparatus 1200 may include a data obtaining module 1210, a target speech extraction module 1220, an adaptive transformation module 1230, and a speech recognition module 1240.

The data obtaining module 1210 may be configured to obtain a to-be-recognized mixed speech spectrum.

The target speech extraction module 1220 may be configured to extract a target speech spectrum from the mixed speech spectrum by using the first subnetwork.

The adaptive transformation module 1230 may be configured to adaptively transform the target speech spectrum by using the second subnetwork, to obtain an intermediate transition representation.

The speech recognition module 1240 may be configured to perform phoneme recognition based on the intermediate transition representation by using the third subnetwork.

In the method provided in this exemplary implementation of this application, the target speech spectrum extracted by using the first subnetwork is adaptively transformed by using the second subnetwork, to obtain the intermediate transition representation that may be inputted to the third subnetwork for phoneme recognition, so as to complete bridging of the speech separation stage and the phoneme recognition stage, to implement an end-to-end speech recognition system. On this basis, the first subnetwork, the second subnetwork, and the third subnetwork are jointly trained, to reduce impact of signal errors and signal distortions introduced in the speech separation stage on performance of the phoneme recognition stage. Therefore, in the method provided in this exemplary implementation of this application, the speech recognition performance under the complex interference sound conditions may be improved to improve user experience; meanwhile, the first subnetwork and the third subnetwork in this exemplary implementation of this application can easily integrate the third-party algorithm and have higher flexibility.

Details of the modules or units in the apparatus have been specifically described in the corresponding exemplary embodiment method. Therefore, details are not described herein again.

In this application, the term “unit” or “module” refers to a computer program or part of the computer program that has a predefined function and works together with other related parts to achieve a predefined goal and may be all or partially implemented by using software, hardware (e.g., processing circuitry and/or memory configured to perform the predefined functions), or a combination thereof. Each unit or module can be implemented using one or more processors (or processors and memory). Likewise, a processor (or processors and memory) can be used to implement one or more modules or units. Moreover, each module or unit can be part of an overall module that includes the functionalities of the module or unit. Although several modules or units of a device for action execution are mentioned in the foregoing detailed descriptions, the division is not mandatory. Actually, according to the implementations of this application, the features and functions of two or more modules or units described above may be specified in one module or unit. Conversely, features and functions of one module or unit described above may be further divided into a plurality of modules or units to be specified.

According to another aspect, this application further provides a non-transitory computer-readable medium. The computer-readable medium may be included in the electronic device described in the foregoing embodiments, or may exist alone and is not disposed in the electronic device. The computer-readable medium carries one or more programs, the one or more programs, when executed by the electronic device, causing the electronic device to implement the method described in the foregoing embodiments. For example, the electronic device may implement steps in the foregoing exemplary embodiments.

The computer-readable medium according to this application may be a computer-readable signal medium or a computer-readable storage medium or any combination of the two media. The computer-readable storage medium may be, for example, but is not limited to, an electric, magnetic, optical, electromagnetic, infrared, or semi-conductive system, apparatus, or component, or any combination thereof. More specifically, the computer-readable storage medium may include, for example, but is not limited to, an electrical connection having one or more wires, a portable computer disk, a hard disk, a RAM, a ROM, an erasable programmable read-only memory (EPROM or flash memory), an optical fiber, a portable compact disc read-only memory (CD-ROM), an optical storage device, a magnetic storage device, or any suitable combination of the foregoing. In this application, the computer-readable storage medium may be any tangible medium including or storing a program, and the program may be used by or in combination with an instruction execution system, apparatus, or device. In this application, a computer-readable signal medium may include a data signal being in a baseband or propagated as a part of a carrier wave, the data signal carrying computer-readable program code. Such a propagated data signal may be in a plurality of forms, including but not limited to an electromagnetic signal, an optical signal, or any suitable combination thereof. The computer-readable signal medium may be further any computer-readable medium in addition to a computer-readable storage medium. The computer-readable medium may send, propagate, or transmit a program that is used by or used in conjunction with an instruction execution system, an apparatus, or a device. The program code contained in the computer readable medium may be transmitted by using any appropriate medium, including but not limited to: a wireless medium, a wire, an optical cable, RF, any suitable combination thereof, or the like.

The flowcharts and block diagrams in the accompanying drawings illustrate possible system architectures, functions, and operations that may be implemented by a system, a method, and a computer program product according to various embodiments of this application. In this regard, each box in a flowchart or a block diagram may represent a module, a program segment, or a part of code. The module, the program segment, or the part of code includes one or more executable instructions used for implementing designated logic functions. In some implementations used as substitutes, functions annotated in boxes may alternatively occur in a sequence different from that annotated in an accompanying drawing. For example, actually two boxes shown in succession may be performed basically in parallel, and sometimes the two boxes may be performed in a reverse sequence. This is determined by a related function. Each box in a block diagram or a flowchart and a combination of boxes in the block diagram or the flowchart may be implemented by using a dedicated hardware-based system configured to perform a designated function or operation, or may be implemented by using a combination of dedicated hardware and a computer instruction.

This application is not limited to the accurate structures that are described above and that are shown in the accompanying drawings, and modifications and changes may be made without departing from the scope of this application. The scope of this application is limited by the appended claims only.

What is claimed is:

1. A method of training a neural network for implementing speech recognition performed by an electronic device, the neural network comprising a first subnetwork, a second subnetwork, and a third subnetwork, the method comprising:
obtaining sample data, the sample data comprising a mixed speech spectrum and a labeled phoneme thereof;
extracting a target speech spectrum from the mixed speech spectrum by using the first subnetwork;
adaptively transforming the target speech spectrum by using the second subnetwork, to obtain an intermediate transition representation;
performing phoneme recognition based on the intermediate transition representation by using the third subnetwork; and
updating parameters of the first subnetwork, the second subnetwork, and the third subnetwork according to a result of the phoneme recognition and the labeled phoneme by:
determining a joint loss function of the first subnetwork, the second subnetwork, and the third subnetwork;
calculating a value of the joint loss function according to the result of the phoneme recognition, the labeled phoneme, and the joint loss function; and
updating the parameters of the first subnetwork, the second subnetwork, and the third subnetwork according to the value of the joint loss function.

2. The neural network training method according to claim 1, wherein the extracting a target speech spectrum from the mixed speech spectrum by using the first subnetwork comprises:
embedding the mixed speech spectrum into a multi-dimensional vector space, to obtain embedding vectors corresponding to time-frequency windows of the mixed speech spectrum;
weighting and regularizing the embedding vectors of the mixed speech spectrum by using an ideal ratio mask (IRM), to obtain an attractor corresponding to the target speech spectrum;
obtaining a target masking matrix corresponding to the target speech spectrum by calculating similarities between the embedding vectors of the mixed speech spectrum and the attractor; and
extracting the target speech spectrum from the mixed speech spectrum based on the target masking matrix.

3. The neural network training method according to claim 2, further comprising:
obtaining attractors corresponding to the sample data, and calculating a mean value of the attractors, to obtain a global attractor.

4. The neural network training method according to claim 1, wherein the adaptively transforming the target speech spectrum by using the second subnetwork comprises:
adaptively transforming target speech spectra of time-frequency windows in sequence according to a sequence of the time-frequency windows of the target speech spectrum, a process of transforming one of the time-frequency windows comprising:
generating hidden state information of a current transformation process according to a target speech spectrum of a time-frequency window targeted by the current transformation process and hidden state information of a previous transformation process; and
obtaining, based on the hidden state information, an intermediate transition representation of the time-frequency window targeted by the current transformation process.

5. The neural network training method according to claim 4, wherein the generating hidden state information of a current transformation process comprises:
calculating candidate state information, an input weight of the candidate state information, a forget weight of target state information of the previous transformation process, and an output weight of target state information of the current transformation process according to a target speech spectrum of a current time-frequency window and the hidden state information of the previous transformation process;
retaining the target state information of the previous transformation process according to the forget weight, to obtain first intermediate state information;
retaining the candidate state information according to the input weight of the candidate state information, to obtain second intermediate state information;
obtaining the target state information of the current transformation process according to the first intermediate state information and the second intermediate state information; and
retaining the target state information of the current transformation process according to the output weight of the target state information of the current transformation process, to obtain the hidden state information of the current transformation process.

6. The neural network training method according to claim 4, wherein the obtaining, based on the hidden state information, an intermediate transition representation of the time-frequency window targeted by the current transformation process comprises:
performing one or more of the following processing on the hidden state information, to obtain the intermediate transition representation of the time-frequency window targeted by the current transformation process:
non-negative mapping, element-wise logarithm finding, calculation of a first-order difference, calculation of a second-order difference, global mean variance normalization, and addition of features of previous and next time-frequency windows.

7. The neural network training method according to claim 1, wherein the performing phoneme recognition based on the intermediate transition representation by using the third subnetwork comprises:
applying a multi-dimensional filter to the intermediate transition representation by using at least one convolutional layer, to generate an output of the convolutional layer;
using the output of the convolutional layer in at least one recursive layer, to generate an output of the recursive layer; and
providing the output of the recursive layer to at least one fully connected layer, and applying a nonlinear function to an output of the fully connected layer, to obtain a posterior probability of a phoneme comprised in the intermediate transition representation.

8. The neural network training method according to claim 7, wherein the recursive layer comprises a long short-term memory (LSTM) network.

9. The neural network training method according to claim 1, wherein the first subnetwork comprises a plurality of layers of LSTM networks of a peephole connection, and the second subnetwork comprises a plurality of layers of LSTM networks of a peephole connection.

10. The neural network training method according to claim 1 further comprising:
obtaining a to-be-recognized mixed speech spectrum;
extracting a target speech spectrum from the mixed speech spectrum by using the first subnetwork;
adaptively transforming the target speech spectrum by using the second subnetwork, to obtain an intermediate transition representation;
performing phoneme recognition based on the intermediate transition representation by using the third subnetwork.

11. An electronic device, comprising:
a processor; and
a memory, configured to store executable instructions of the processor,
the processor being configured to, when executing the executable instructions, perform a plurality of operations including:
extracting a target speech spectrum from the mixed speech spectrum by using the first subnetwork;
adaptively transforming the target speech spectrum by using the second subnetwork, to obtain an intermediate transition representation;
performing phoneme recognition based on the intermediate transition representation by using the third subnetwork; and
updating parameters of the first subnetwork, the second subnetwork, and the third subnetwork according to a result of the phoneme recognition and the labeled phoneme by:
determining a joint loss function of the first subnetwork, the second subnetwork, and the third subnetwork;
calculating a value of the joint loss function according to the result of the phoneme recognition, the labeled phoneme, and the joint loss function; and
updating the parameters of the first subnetwork, the second subnetwork, and the third subnetwork according to the value of the joint loss function.

12. The electronic device according to claim 11, wherein the extracting a target speech spectrum from the mixed speech spectrum by using the first subnetwork comprises:
embedding the mixed speech spectrum into a multi-dimensional vector space, to obtain embedding vectors corresponding to time-frequency windows of the mixed speech spectrum;
weighting and regularizing the embedding vectors of the mixed speech spectrum by using an ideal ratio mask (IRM), to obtain an attractor corresponding to the target speech spectrum;
obtaining a target masking matrix corresponding to the target speech spectrum by calculating similarities between the embedding vectors of the mixed speech spectrum and the attractor; and
extracting the target speech spectrum from the mixed speech spectrum based on the target masking matrix.

13. The electronic device according to claim 12, wherein the plurality of operations further comprise:
obtaining attractors corresponding to the sample data, and calculating a mean value of the attractors, to obtain a global attractor.

14. The electronic device according to claim 11, wherein the adaptively transforming the target speech spectrum by using the second subnetwork comprises:
adaptively transforming target speech spectra of time-frequency windows in sequence according to a sequence of the time-frequency windows of the target speech spectrum, a process of transforming one of the time-frequency windows comprising:
generating hidden state information of a current transformation process according to a target speech spectrum of a time-frequency window targeted by the current transformation process and hidden state information of a previous transformation process; and
obtaining, based on the hidden state information, an intermediate transition representation of the time-frequency window targeted by the current transformation process.

15. The electronic device according to claim 11, wherein the performing phoneme recognition based on the intermediate transition representation by using the third subnetwork comprises:
applying a multi-dimensional filter to the intermediate transition representation by using at least one convolutional layer, to generate an output of the convolutional layer;
using the output of the convolutional layer in at least one recursive layer, to generate an output of the recursive layer; and
providing the output of the recursive layer to at least one fully connected layer, and applying a nonlinear function to an output of the fully connected layer, to obtain a posterior probability of a phoneme comprised in the intermediate transition representation.

16. The electronic device according to claim 11, wherein the first subnetwork comprises a plurality of layers of LSTM networks of a peephole connection, and the second subnetwork comprises a plurality of layers of LSTM networks of a peephole connection.

17. The electronic device according to claim 11, wherein the plurality of operations further comprise:
obtaining a to-be-recognized mixed speech spectrum;
extracting a target speech spectrum from the mixed speech spectrum by using the first subnetwork;
adaptively transforming the target speech spectrum by using the second subnetwork, to obtain an intermediate transition representation;
performing phoneme recognition based on the intermediate transition representation by using the third subnetwork.

18. A non-transitory computer-readable storage medium, storing executable instructions, the executable instructions, when executed by a processor of an electronic device, causing the electronic device to perform a plurality of operations including:
extracting a target speech spectrum from the mixed speech spectrum by using the first subnetwork;
adaptively transforming the target speech spectrum by using the second subnetwork, to obtain an intermediate transition representation;
performing phoneme recognition based on the intermediate transition representation by using the third subnetwork; and
updating parameters of the first subnetwork, the second subnetwork, and the third subnetwork according to a result of the phoneme recognition and the labeled phoneme by:
determining a joint loss function of the first subnetwork, the second subnetwork, and the third subnetwork;
calculating a value of the joint loss function according to the result of the phoneme recognition, the labeled phoneme, and the joint loss function; and
updating the parameters of the first subnetwork, the second subnetwork, and the third subnetwork according to the value of the joint loss function.

19. The non-transitory computer-readable storage medium according to claim 18, wherein the extracting a target speech spectrum from the mixed speech spectrum by using the first subnetwork comprises:
embedding the mixed speech spectrum into a multi-dimensional vector space, to obtain embedding vectors corresponding to time-frequency windows of the mixed speech spectrum;
weighting and regularizing the embedding vectors of the mixed speech spectrum by using an ideal ratio mask (IRM), to obtain an attractor corresponding to the target speech spectrum;
obtaining a target masking matrix corresponding to the target speech spectrum by calculating similarities between the embedding vectors of the mixed speech spectrum and the attractor; and
extracting the target speech spectrum from the mixed speech spectrum based on the target masking matrix.

20. The non-transitory computer-readable storage medium according to claim 18, wherein the plurality of operations further comprise:
obtaining a to-be-recognized mixed speech spectrum;
extracting a target speech spectrum from the mixed speech spectrum by using the first subnetwork;
adaptively transforming the target speech spectrum by using the second subnetwork, to obtain an intermediate transition representation;
performing phoneme recognition based on the intermediate transition representation by using the third subnetwork.
